(19) United States
(12) Patent Application Publication
(10) Pub. No.: US 2021/0074168 A1
(43) Pub. Date: Mar. 11, 2021

(54) FLIGHT CONTROL SYSTEM AND FLIGHT CONTROL APPARATUS

(71) Applicant: NTT DOCOMO, INC., Tokyo (JP)

(72) Inventors: Takefumi YAMADA, Tokyo (JP); Ken KOUMOTO, Tokyo (JP); Hidetoshi EBARA, Tokyo (JP); Youhei OONO, Toyko (JP); Yuichiro SEGAWA, Tokyo (JP); Yukiko NAKAMURA, Toyko (JP)

(73) Assignee: NTT DOCOMO, INC., Tokyo (JP)

(21) Appl. No.: 16/644,663

(22) PCT Filed: Jul. 11, 2018
(86) PCT No.: PCT/JP2018/026164

§ 371 Date: Mar. 5, 2020

(30) Foreign Application Priority Data
Sep. 15, 2017 (JP) 2017-177927

(51) Int. Cl. G08G 5/00; G08G 5/04

(52) U.S. Cl. CPC G08G 5/0039; G08G 5/0069; G08G 5/045; G08G 5/006

(57) ABSTRACT

A flight control system includes an acquiring unit that acquires a flight plan in which a first flight condition is described. A setting unit sets a degree of risk in an airspace where a flying object flies. A determining unit determines a second flight condition based on an object detected within a predetermined range from the flying object. A flight control unit controls flight of the flying object by switching between a first flight control method according to the first flight condition and a second flight control method according to a part of the first flight condition and the second flight condition in accordance with the degree of risk. In a case where the degree of risk in an airspace included in at least one airspace exceeds a predetermined level, the flight control unit selects the second flight control method to control the flying object in the airspace.

### TECHNICAL FIELD

The present invention relates to a technology of controlling the flight of a flying object.

### BACKGROUND ART

There has been known a technology of controlling the flight of a flying object. For example, Japanese Patent Application No. JP 2017-65297 discloses a flight control apparatus that judges that the present state is a required risk avoidance state when the speed and attitude of the flying object become excessive in case of a manual control mode and disables a manual operation to perform automatic pilot. Japanese Patent Application No. JP 2017-07588 discloses that, when a control program operating in a flight control apparatus is locked or runs uncontrollably due to noise or bugs to disable the control of a driving device, the control of the driving device switches from the control performed by the flight control apparatus based on the instruction operation of an operator to the control autonomously performed by an autonomous flight apparatus regardless of the instruction operation of the operator.

### SUMMARY OF THE INVENTION

Among unmanned flying objects such as drones, there is a flying object that can fly in accordance with a predetermined flight plan even if a person does not operate it. However, when a degree of risk in an airspace where the flying object flies is high like when there are many obstacles, for example, the flying object may not safely fly when flying only according to the predetermined flight plan.

An object of the invention is to perform safer flight control in accordance with a degree of risk in an airspace where a flying object flies.

The present invention provides a flight control system that includes: an acquiring unit configured to acquire a flight plan in which a first flight condition is described; a setting unit configured to set a degree of risk in an airspace where a flying object flies; a determining unit configured to determine a second flight condition; and a flight control unit configured to control flight of the flying object by switching between a first flight control method according to the first flight condition and a second flight control method according to a part of the first flight condition and the determined second flight condition in accordance with the degree of risk.

The acquiring unit may further acquire a flight instruction, and the flight control unit may switch between the first flight control method, the second flight control method, and a third flight control method according to the acquired flight instruction, in accordance with the degree of risk.

The flight plan may include a passing place, a destination place, and a path described therein, the determining unit may determine a new path toward the destination place through the passing place described in the flight plan, and the flight control unit may control the flight so that the flying object goes through the determined new path in the second flight control method.

The flight control system may further include: a positioning unit configured to measure a position of the flying object; and a detecting unit configured to detect an object located in a predetermined range from the flying object, and the determining unit may determine the new path based on the measured position and the detected object.

The setting unit may set the degree of risk in accordance with a ground congestion degree corresponding to the airspace, an altitude of the airspace, a congestion degree of the airspace, an attribute of the airspace, or a flight operation of the flying object performed in the airspace.

Moreover, the present invention provides a flight control system that includes: a setting unit configured to set a degree of risk in an airspace where a flying object flies; a generating unit configured to generate a second flight plan including a part of a first flight condition described in a first flight plan when the set degree of risk is equal to or more than a predetermined degree; a transmitting unit configured to transmit the first flight plan and the generated second flight plan to the flying object; an acquiring unit configured to acquire the transmitted first flight plan and second flight plan; a determining unit configured to determine a second flight condition; and a flight control unit configured to control flight of the flying object by switching between a first flight control method according to the first flight condition described in the acquired first flight plan and a second flight control method according to the acquired second flight plan and the determined second flight condition in accordance with the degree of risk.

Furthermore, the present invention provides a flight control apparatus that includes: an acquiring unit configured to acquire a flight plan in which a first flight condition is described and a degree of risk in an airspace where a flying object flies; a determining unit configured to determine a second flight condition; and a flight control unit configured to control flight of the flying object by switching between a first flight control method according to the first flight condition and a second flight control method according to a part of the first flight condition and the determined second flight condition in accordance with the degree of risk.

According to the present invention, safer flight control can be performed in accordance with a degree of risk in an airspace where a flying object flies.

### BRIEF DESCRIPTION OF DRAWINGS

FIG. 1 is a diagram illustrating a configuration example of a flight control system 1, in accordance to the present invention.

FIG. 2 is a diagram illustrating an example of the appearance of a flying object 10, in accordance to the present invention.

FIG. 3 is a diagram illustrating the hardware configuration of the flying object 10, in accordance to the present invention.

FIG. 4 is a diagram illustrating the hardware configuration of a server apparatus 20, in accordance to the present invention.

FIG. 5 is a diagram illustrating an example of the functional configuration of the flight control system 1, accordance to the present invention.

FIG. 6 is a sequence chart illustrating an example of operations of the flight control system 1 according to a first embodiment, in accordance to the present invention.

FIG. 7 is a diagram illustrating an example of a flight plan 121, in accordance to the present invention.

FIG. 8 is a diagram illustrating an example of an airspace, in accordance to the present invention.

FIG. 9 is a diagram illustrating an example of a flight path R1, in accordance to the present invention.

FIG. 10 is a diagram illustrating an example of a flight control according to a degree of risk, in accordance to the present invention.

FIG. 11 is a flowchart illustrating the flight control of the flying object 10, in accordance to the present invention.

FIG. 12 is a sequence chart illustrating an example of operations of the flight control system 1 according to a second embodiment, in accordance to the present invention.

FIG. 13 is a diagram illustrating an example of a flight plan 122 according to the second embodiment, in accordance to the present invention.

The following describes a first embodiment of the present invention with references to the drawings.

Configuration

FIG. 1 is a diagram illustrating a configuration example of a flight control system 1. The flight control system 1 is a system that controls the flight of a flying object 10. The flight control system 1 includes a plurality of the flying objects 10 and a server apparatus 20.

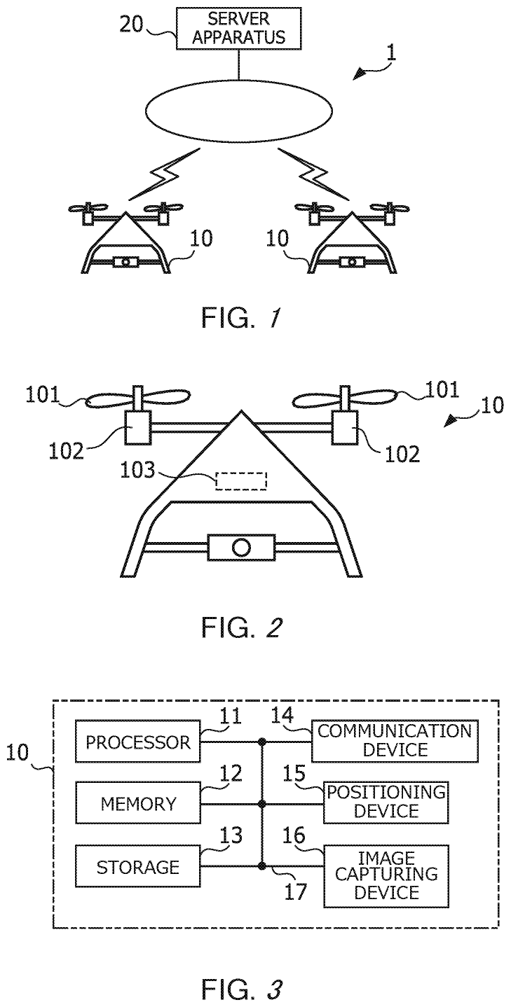

FIG. 2 is a diagram illustrating an example of the appearance of the flying object 10. The flying object 10 is an unmanned aircraft that can autonomously fly even if a person does not operate it. The flying object 10 is a drone for example. The flying object 10 includes propellers 101, driving devices 102, and a battery 103.

The propellers 101 rotate around their axes. The flying object 10 flies by rotating the propellers 101. The driving devices 102 power the respective propellers 101 to rotate them. The driving devices 102 are a motor for example. The driving devices 102 may be directly connected to the respective propellers 101 or may be connected to the respective propellers 101 via transmission mechanisms for transmitting the power of the driving devices 102 to the propellers 101. The battery 103 supplies electric power to components of the flying object 10 that includes the driving devices 102.

FIG. 3 is a diagram illustrating the hardware configuration of the flying object 10. The flying object 10 may be physically configured as computer equipment that includes a processor 11, a memory 12, a storage 13, a communication device 14, a positioning device 15, an image capturing device 16, a bus 17, and the like. In addition, in the following explanations, words called “device/apparatus/equipment” may be read as a circuit, a device, a unit, etc.

The processor 11 activates an operating system to totally control the computer, for example. The processor 11 may be configured by a central processing unit (CPU) that includes an interface with a peripheral device, a control device, an arithmetic device, a register, etc.

Moreover, the processor 11 reads a program (program codes), a software module, and data to the memory 12 from the storage 13 and/or the communication device 14 and executes various types of processes in accordance with these. The program employs a program making the computer execute at least part of the motion of the flying object 10. Various types of processes executed in the flying object 10 may be executed by the one processor 11 or may be simultaneously or sequentially executed by two or more the processors 11. The processor 11 may be implemented by one or more chips. In addition, the program may be transmitted from a network via a telecommunications line.

The memory 12 is a computer-readable recording medium. For example, the memory may be configured by at least one of ROM (Read Only Memory), EPROM (Erasable Programmable ROM), EEPROM (Electrically Erasable Programmable ROM), RAM (Random Access Memory), etc. The memory 12 may be referred to as a register, a cache, a main memory (main memory unit), etc. The memory 12 can save executable program (program codes), software module, etc. to perform a flight control method according to one embodiment of the present invention.

The storage 13 is a computer-readable recording medium. For example, the storage may be configured by at least one of an optical disc such as CD-ROM (Compact Disc ROM), a hard disk drive, a flexible disk, a magneto-optical disc (e.g., compact disc, digital versatile disc, Blu-ray (registered trademark) disc), a smart card, a flash memory (e.g., card, stick, key drive), floppy (registered trademark) disk, a magnetic strip, etc. The storage 13 may be referred to as an auxiliary storage device.

The communication device 14 is hardware (transceiving device) to perform communication between computers via wired and/or wireless network. For example, the communication device is also called a network device, a network controller, a network card, a communication module, etc.

The positioning device 15 measures the three-dimensional position of the flying object 10. The positioning device 15 is a GPS (Global Positioning System) receiver for example, and measures the present position of the flying object 10 based on a GPS signal received from a plurality of satellites.

The image capturing device 16 captures images around the flying object 10. The image capturing device 16 is a camera for example and makes an image on an imaging element by using an optical system to capture the image. The image capturing device 16 captures predetermined-range images in front of the flying object 10, for example. In this regard, however, the shooting direction of the image capturing device 16 is not limited to the front side of the flying object 10, and thus may be the upper side, the lower side, or the rear side of the flying object 10. Moreover, the shooting direction may be changed by rotating a pedestal supporting the image capturing device 16 for example.

Moreover, devices such as the processor 11 and the memory 12 are connected to each other by using the bus 17 to communicate information. The bus 17 may be configured by a single bus or may be configured by different buses between the devices.

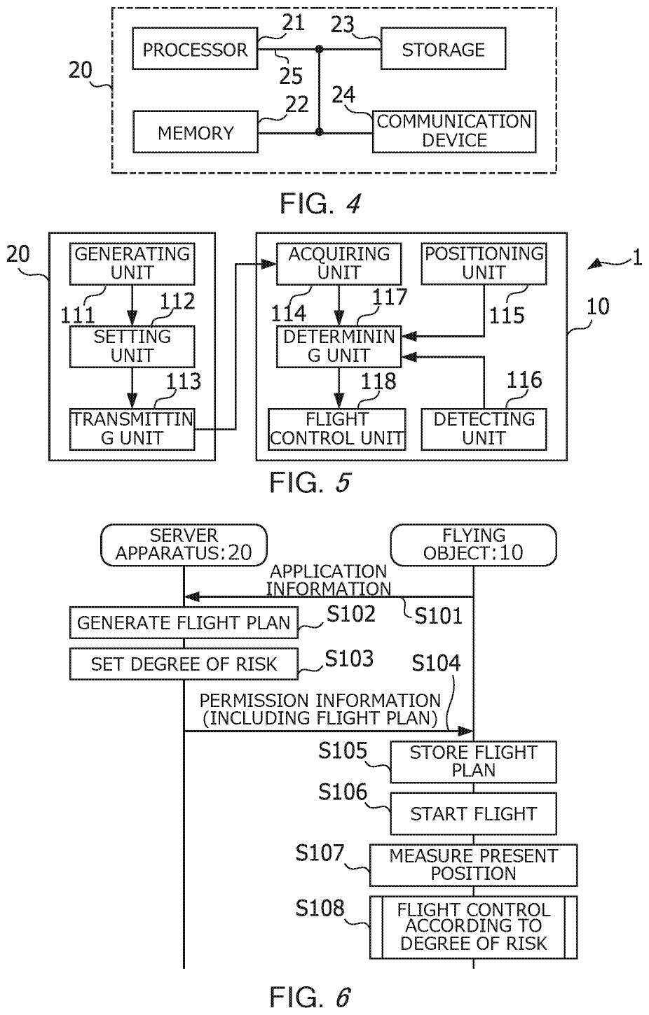

FIG. 4 is a diagram illustrating the hardware configuration of the server apparatus 20. The server apparatus 20 plays a role in operational management for the flying object 10. The “operational management” means to manage air traffic of the flying object 10. For example, when the flying object 10 is an unmanned aircraft such as a drone, the operational management includes the setting of the flight airspace and the control of the flight path of the flying object 10. In this regard, however, “operational management” is a concept that can include not only the management of such an unmanned aircraft but also the air traffic control of a manned aircraft, for example, the understanding and notification of the entire airspace where the manned aircraft flies.

The server apparatus 20 may be physically configured as computer equipment that includes a processor 21, a memory 22, a storage 23, a communication device 24, a bus 25, and the like. Because the processor 21, the memory 22, the storage 23, the communication device 24, and the bus 25 are similar to the processor 11, the memory 12, the storage 13, the communication device 14, and the bus 17 described above, their descriptions are omitted.

FIG. 5 is a diagram illustrating an example of the functional configuration of the flight control system 1. The flight control system 1 functions as a generating unit 111, a setting unit 112, a transmitting unit 113, an acquiring unit 114, a positioning unit 115, a detecting unit 116, a determining unit 117, and a flight control unit 118. In this example, the generating unit 111, the setting unit 112, and the transmitting unit 113 are implemented in the server apparatus 20. Each function in the server apparatus 20 is realized by loading predetermined software (program) into hardware such as the processor 21 and the memory 22 to make the processor 21 perform calculation and by controlling the communication by the communication device 24 and the reading and/or writing of data from/into the memory 22 and the storage 23. On the other hand, the acquiring unit 114, the positioning unit 115, the detecting unit 116, the determining unit 117, and the flight control unit 118 are implemented in the flying object 10. Each function in the flying object 10 is realized by loading predetermined software (program) into hardware such as the processor 11 and the memory 12 to make the processor 11 perform calculation and by controlling the communication by the communication device 14 and the reading and/or writing of data from/into the memory 12 and the storage 13. In this case, the flying object 10 functions as a flight control apparatus.

The generating unit 111 generates a flight plan 121 of the flying object 10. The flight plan 121 means information indicating the plan of flight. A first flight condition is described in the flight plan 121. A flight condition means a condition to be followed when the flying object 10 flies. The flight condition is used for the flight control of the flying object 10.

The setting unit 112 sets a degree of risk in an airspace where the flying object 10 flies. The degree of risk means a degree of risk in an airspace. The term called “risk” has two meanings of the height of the possibility that the flying object 10 collides with another object and the size of damage to be assumed when the flying object 10 falls. For example, the degree of risk may become higher as the possibility that the flying object 10 collides with another object in the airspace is higher. Moreover, the degree of risk may become higher as damage to be assumed when the flying object 10 falls in the airspace is larger. In addition, the fact that the damage to be assumed when the flying object 10 falls is large means that a safety degree required for the airspace is high.

The transmitting unit 113 transmits the flight plan 121 generated by the generating unit 111 to the flying object 10. Moreover, when the flying object 10 is manually operated by an aircraft dispatcher, the transmitting unit 113 transmits a flight instruction input by the aircraft dispatcher to the flying object 10. The acquiring unit 114 acquires the flight plan 121 and the flight instruction transmitted by the transmitting unit 113.

The positioning unit 115 measures the position of the flying object 10. For example, the positioning unit 115 is realized by the positioning device 15 described above. The detecting unit 116 detects an object located in a predetermined range from the flying object 10. For example, the detecting unit 116 performs image recognition processing on the images captured by the image capturing device 16 to detect an object located in a predetermined range from the flying object 10. This object is an obstacle, which impede flight, such as the other flying object 10, a bird, a natural object, and a building structure.

The determining unit 117 determines a second flight condition. At this time, the determining unit 117 may determine the second flight condition based on the position measured by the positioning unit 115 and the object detected by the detecting unit 116.

The flight control unit 118 controls the flight of the flying object 10 in accordance with the first flight condition described in the flight plan 121 acquired by the acquiring unit 114, the second flight condition determined by the determining unit 117, or the flight instruction acquired by the acquiring unit 114. For example, the flight control unit 118 may selectively or adaptively employ: a first flight control according to the first flight condition described in the flight plan 121; a second flight control according to the part of the first flight condition and the second flight condition; or a third flight control according to the flight instruction, in accordance with the degree of risk set by the setting unit 112.

In the following explanation, when the flying object 10 is described as a subject of processing, this specifically means that the processor 11 performs calculation by loading the predetermined software (program) into hardware such as the processor 11 and the memory 12 and processing is executed by controlling the communication by the communication device 14 and the reading and/or writing of data from/into the memory 12 and the storage 13. The same is similarly applied to the server apparatus 20.

Operations

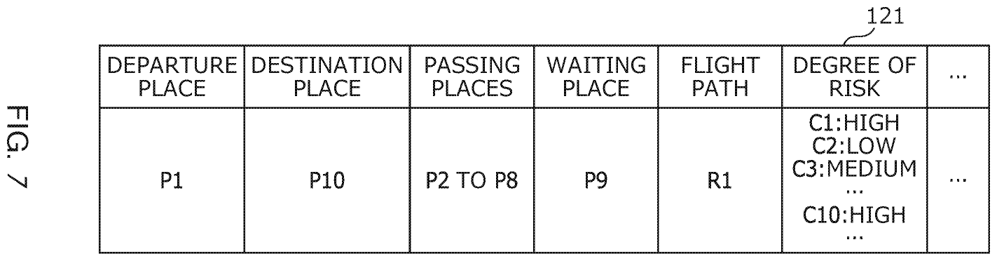

FIG. 6 is a sequence chart illustrating an example of operations of the flight control system 1 according to the first embodiment. Before the flying object 10 flies, the process of Step S101 is started.

In Step S101, the flying object 10 transmits application information to apply for flight permission. This application information includes flight conditions such as flight date/time, flight path, and flight altitude.

In Step S102, the generating unit 111 of the server apparatus 20 generates the flight plan 121 of the flying object 10 based on the application information received from the flying object 10.

FIG. 7 is a diagram illustrating an example of the flight plan 121. A departure place, a destination place, passing places, a waiting place, and a flight path are described in the flight plan 121. The departure place is a place at which the flying object 10 starts. The destination place is a place that is regarded as the purpose of flight of the flying object 10. The passing places are places through which the flying object 10 should go between the departure place and the destination place. The waiting place is a place at which the flying object 10 temporarily waits. The flight path is a three-dimensional air route that the flying object 10 should follow.

In this example, a departure place P1, a destination place P10, passing places P2 to P8, a waiting place P9, and a flight path R1 are described in the flight plan 121. These flight conditions may be flight conditions included in the application information or may be set by the server apparatus 20. For example, flight conditions may be set based on the attributes of an airspace where the flying object 10 flies.

FIG. 8 is a diagram illustrating an example of the airspace. In this example, the airspace is divided into a plurality of airspace cells C. Each of the airspace cells C is a three-dimensional space. The airspace cells C have a tubular shape for example. In this regard, however, the shape of the airspace cells C is not limited to the tubular shape, and thus may have a shape, other than the tubular shape, such as a prismatic column.

Attributes may be set for the airspace cells C. The attributes may include a flight direction and the type of airspace, for example. For example, when a flight direction from the south toward the north is set for the airspace cell C1, the flying object 10 can fly in the airspace cell C1 to only this flight direction. The type of airspace includes a shared airspace and an exclusive airspace, for example. The plurality of flying objects 10 can simultaneously fly in the shared airspace. On the other hand, only the one flying object 10 can simultaneously fly in the exclusive airspace. For example, when the airspace cell C1 is set as the exclusive airspace and the airspace cell C1 is assigned to the other flying object 10 between 13:00 and 15:00, the flying object 10 cannot pass through the airspace cell C1 in this time zone. The flight path R1 described above may be set based on the attributes of such the airspace cells C.

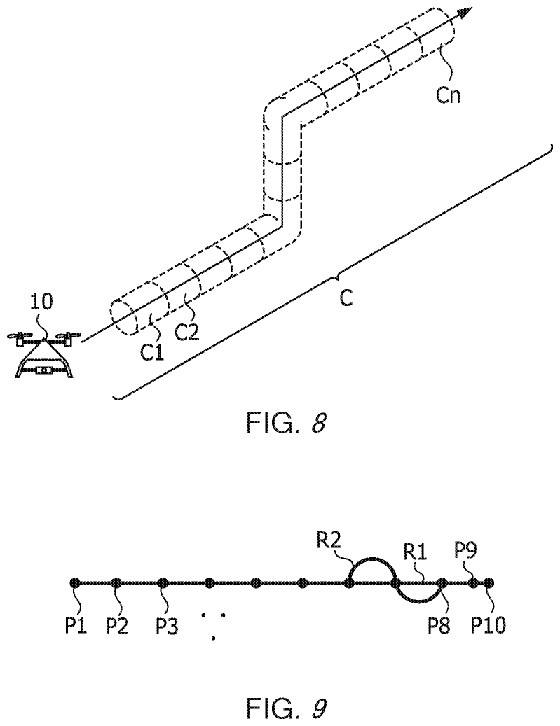

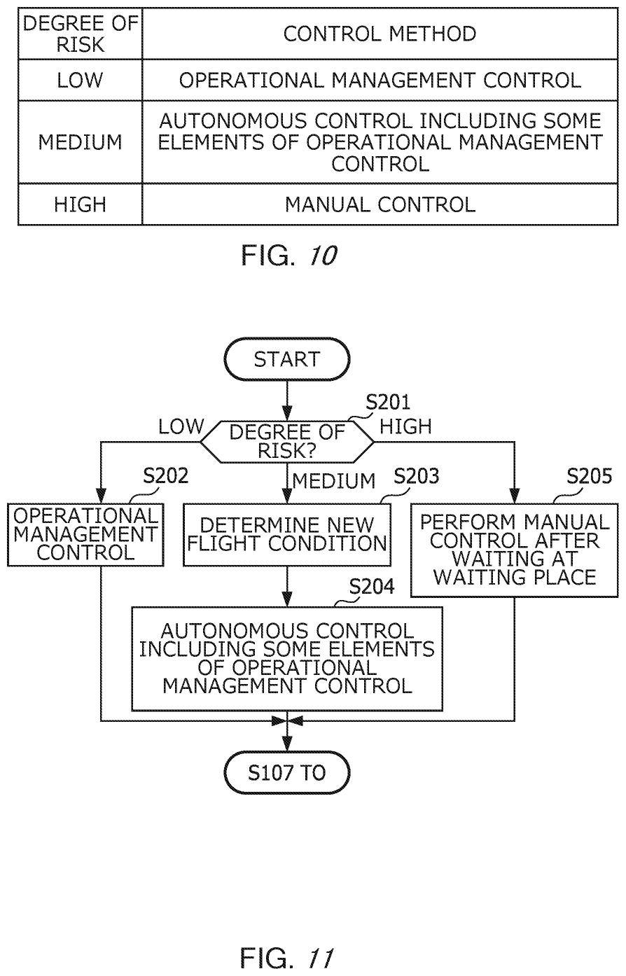

FIG. 9 is a diagram illustrating an example of the flight path R1. The flight path R1 is a path from the departure place P1 toward the destination place P10 via the passing places P2 to P8. Moreover, the waiting place P9 is located near the destination place P10. When the flight path R1 is set, the airspace cells C1 to Cn on the flight path R1 are assigned to the flying object 10. Alternatively, the flight path R1 itself may be represented by the plurality of consecutive airspace cells C.

In Step S103, the setting unit 112 of the server apparatus 20 sets a degree of risk in the airspace cells C. Hereinafter, the setting way of the degree of risk in the airspace cells C will be explained with some examples.

The degree of risk may be set in accordance with a ground congestion degree corresponding to the airspace cells C, for example. The ground congestion degree is a population density for example. For example, when the population density of a ground area located below the airspace cells C is equal to or more than a predetermined population density, the degree of risk “medium” may be set for the airspace cells C. On the other hand, when this population density is less than the predetermined population density, the degree of risk “low” may be set for the airspace cells C. This is because damage when the flying object 10 falls is large when the population density of the ground area is high. In addition, the population density of the ground area may not be determined strictly. For example, a population density may be regarded to be high when the ground area is a town and a population density may be regarded to be low when the ground area is a country.

In another example, the degree of risk may be set in accordance with the altitude of the airspace cells C. For example, when the altitude of the airspace cells C is equal to or more than a predetermined altitude, the degree of risk “medium” may be set for the airspace cells C. On the other hand, when the altitude of the airspace cells C is less than the predetermined altitude, the degree of risk “low” may be set for the airspace cells C. This is because damage when the flying object 10 falls is large when the altitude of the airspace cells C where the flying object 10 flies is high.

In the other example, the degree of risk may be set in accordance with the congestion degree of the airspace cells C. For example, the congestion degree of the airspace cells C is a density of the flying objects 10 located in the same airspace cells C. This density may be calculated based on the number of the flying objects 10 detected by the detecting unit 116, for example. For example, when the density of the flying objects 10 located in the airspace cells C is equal to or more than a predetermined density, the degree of risk “medium” may be set for the airspace cells C. On the other hand, when the density of the flying objects 10 located in the airspace cells C is less than the predetermined density, the degree of risk “low” may be set for the airspace cells C. This is because a possibility that the flying objects 10 collide against each other becomes high when the congestion degree of the airspace cells C where the flying object 10 flies is high.

In the other example, the degree of risk may be set in accordance with the attributes of the airspace cells C. For example, when the airspace cells C are a shared airspace, the degree of risk “medium” may be set for the airspace cells C. On the other hand, when the airspace cells C are an exclusive airspace, the degree of risk “low” may be set for the airspace cells C. This is because a possibility that the flying objects 10 collide against each other becomes high because the plurality of flying objects 10 can simultaneously fly in the shared airspace.

In the other example, the degree of risk may be set in accordance with the flight operation of the flying object 10 that is performed in the airspace cells C. For example, when the flying object 10 performs work in the airspace cells C, the degree of risk “high” may be set for the airspace cells C. For example, this work may be photographing or may be measurement. Moreover, when the flying object 10 performs takeoff and landing in the airspace cells C, the degree of risk “high” may be set for the airspace cells C. On the other hand, when the flying object 10 moves in the airspace cells C, the degree of risk “low” may be set for the airspace cells C. This is because a possibility that the flying object 10 collides with another object becomes high when the flying object 10 performs work or performs takeoff and landing.

In the other example, the degree of risk may be set in accordance with a combination of at least two of the ground congestion degree corresponding to the airspace cells C, the altitude of the airspace cells C, the congestion degree of the airspace cells C, the attributes of the airspace cells C, and the flight operation of the flying object 10 performed in the airspace cells C, as described above.

Moreover, the setting unit 112 describes the degree of risk set in this way in the flight plan 121. In this example, as illustrated in FIG. 7, the degree of risk “low”, “medium”, or “high” set for the airspace cells C1 to Cn on the flight path R1 is described in the flight plan 121.

In Step S104, the transmitting unit 113 of the server apparatus 20 transmits permission information to permit the flight to the flying object 10. The permission information includes the flight plan 121 generated in Step S102. The acquiring unit 114 of the flying object 10 receives the permission information from the server apparatus 20.

In Step S105, the flying object 10 causes the storage 13 to store the flight plan 121 included in the received permission information.

In Step S106, the flying object 10 starts to fly in accordance with the flight plan 121 stored in the storage 13. More specifically, the flight control unit 118 controls the driving devices 102 so as to fly along the flight path R1 described in the flight plan 121. Under the control of the flight control unit 118, the propellers 101 are rotated by driving the driving devices 102 and the flying object 10 is made to fly.

In Step S107, the positioning unit 115 of the flying object 10 measures the present position of the flying object 10 at predetermined time intervals.

In Step S108, the flight control unit 118 of the flying object 10 performs flight control according to the degree of risk in the airspace cells C where the flying object 10 flies. The airspace cells C where the flying object 10 flies are specified based on the position measured in Step S107.

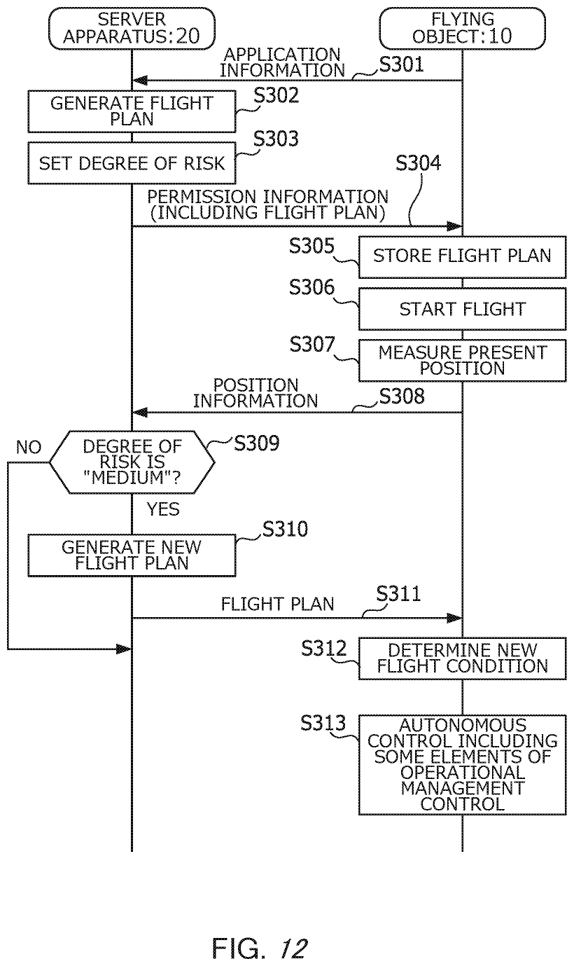

FIG. 10 is a diagram illustrating an example of the flight control according to the degree of risk. When the degree of risk in the airspace cells C where the flying object 10 flies is “low”, the flying object 10 flies by operational management control. The operational management control means to control the flight in accordance with the flight plan 121. The operational management control is an example of the first flight control described above. When the degree of risk in the airspace cells C where the flying object 10 flies is “medium”, the flying object 10 flies by autonomous control including some elements of the operational management control. The autonomous control means to control the flight in accordance with a flight condition determined by the flying object 10 itself independently of the flight plan 121. The autonomous control including some elements of the operational management control is an example of the second flight control described above. When the degree of risk in the airspace cells C where the flying object 10 flies is “high”, the flying object 10 mainly flies by manual control. The manual control means to control the flight in accordance with the operation of the aircraft dispatcher. The manual control is an example of the third flight control described above. In this way, the flying object 10 switches between the flight control methods in accordance with the degree of risk in the airspace cells C where the flying object 10 flies.

FIG. 11 is a flowchart illustrating the flight control of the flying object 10. The processes illustrated in FIG. 11 are performed in Step S108 described above.

In Step S201, the flying object 10 judges whether the degree of risk in the airspace cells C where the flying object 10 flies is “low”, “medium”, or “high”. For example, when the flying object 10 flies in the airspace cell C2, because the degree of risk in the airspace cell C2 described in the flight plan 121 is “low” as illustrated in FIG. 7, “low” is judged as the degree of risk (Step S201: “low”). In this case, the process proceeds to Step S202.

In Step S202, the flight control unit 118 performs the operational management control. More specifically, the flight control unit 118 controls the flight in accordance with all the flight conditions described in the flight plan 121. For example, the flight control unit 118 performs flight control to go through the flight path R1 described in the flight plan 121. By this flight control, the flying object 10 flies to the destination place P10 via the passing places P2 to P8 through the flight path R1. The flying object 10 does not fly through a path different from the flight path R1 during the operational management control. In this regard, however, the flying object 10 may suspend or may wait in accordance with the position measured by the positioning unit 115 or the obstacle detected by the detecting unit 116.

On the other hand, in Step S201 described above, when the flying object 10 flies in the airspace cell C3 for example, because the degree of risk in the airspace cell C3 described in the flight plan 121 is “medium” as illustrated in FIG. 7, “medium” is judged as the degree of risk (Step S201: “medium”). In this case, the process proceeds to Step S203.

In Step S203, the determining unit 117 disables some of the flight conditions described in the flight plan 121, and determines a new flight condition based on the position measured by the positioning unit 115 and the object detected by the detecting unit 116. For example, the determining unit 117 disables the flight path R1 described in the flight plan 121. Then, the determining unit 117 determines a new flight path R2 from the position measured by the positioning unit 115 toward the destination place P10 via the passing places P2 to P8 described in the flight plan 121 while avoiding collision with the object detected by the detecting unit 116. As illustrated in FIG. 9, at least part of the flight path R2 is different from the flight path R1 described in the flight plan 121. In this regard, however, the flight path R2 may be the same as the flight path R1 in some cases.

In Step S204, the flight control unit 118 performs the autonomous control including some elements of the operational management control. More specifically, the flight control unit 118 controls the flight in accordance with the effective flight conditions described in the flight plan 121 and the new flight condition determined in Step S203. For example, when the flight path R1 is disabled in Step S203 described above, the effective flight conditions are the flight conditions other than the flight path R1, namely the departure place P1, the destination place P10, the passing places P2 to P8, and the waiting place P9. For example, the flight control unit 118 performs the flight control to go through the new flight path R2 determined in Step S203. As a result, the flying object 10 flies to the destination place P10 via the passing places P2 to P8 through the flight path R2.

On the other hand, in Step S201 described above, when the flying object 10 flies in the airspace cell C10 for example, because the degree of risk in the airspace cell C10 described in the flight plan 121 is “high” as illustrated in FIG. 7, “high” is judged as the degree of risk (Step S201: “high”). In this case, the process proceeds to Step S205.

In Step S205, the flight control unit 118 causes the flying object to wait at the waiting place P9 described in the flight plan 121 and then performs the manual control. For example, the flight control unit 118 controls the flight to stop in an aerial region at the waiting place P9. By such the flight control, the flying object 10 stops in the aerial region at the waiting place P9. when the flying object 10 arrives at the waiting place P9, the aircraft dispatcher manually operates the flying object 10. In addition, the fact that the flying object 10 has arrived at the waiting place P9 may be recognized by transmitting position information indicating the present position measured by the positioning unit 115 from the flying object 10 to the server apparatus 20 and outputting the position information by the server apparatus 20, for example. The aircraft dispatcher operates a terminal device, not illustrated for example, to input a flight instruction. The flight instruction input into the terminal device is transmitted to the flying object 10 through the transmitting unit 113 of the server apparatus 20. The acquiring unit 114 of the flying object 10 receives the flight instruction from the server apparatus 20. The flight control unit 118 controls the flight in accordance with the received flight instruction. For example, when a flight instruction indicating to go left is received, the flight is controlled so that the flying object 10 goes left.

When the process of Step S202, S204, or S205 is terminated, the process returns to Step S107 described above and the processes after Step S107 are repeated.

According to the first embodiment described above, the autonomous control including some elements of the operational management control is performed when the degree of risk in the airspace cells C where the flying object 10 flies is “medium”. In the autonomous control including some elements of the operational management control, the flying object 10 itself can determine some of the flight conditions, for example, in accordance with the status and environment of the flying object 10 independently of the flight plan 121. In this case, because a possibility that the flying object collides against an obstacle becomes low even if the obstacle exists in the airspace cells C for example, the safety of flight becomes high as compared to the case where the operational management control is performed. In this way, according to the first embodiment described above, safer flight control can be performed as compared to the case where the operational management control is performed when the degree of risk in the airspace cells C where the flying object 10 flies is “medium”.

Moreover, in the autonomous control including some elements of the operational management control, because some of the flight conditions described in the flight plan 121 are effective, the flying object 10 can be made to fly in accordance with the operational management control to some extent. For that reason, as compared to the case where the flying object 10 totally flies by the autonomous control, a possibility that the flying objects 10 collide against each other becomes low and thus the safety of flight becomes high.

Moreover, when the degree of risk in the airspace cells C where the flying object 10 flies is “high”, the manual control is performed in accordance with the operation of the aircraft dispatcher because a possibility that an accident such as collision occurs is high. In this case, the safety of flight becomes higher by the appropriate operation of the aircraft dispatcher. In this way, according to the first embodiment described above, safer flight control can be performed as compared to the case where the operational management control is performed when the degree of risk in the airspace cells C where the flying object 10 flies is “high”.

Furthermore, when the degree of risk in the airspace cells C where the flying object 10 flies is “low”, the operational management control is performed because a possibility that an accident such as collision occurs is low even if the flying object flies in accordance with the flight plan 121. In this case, because the flying object 10 does not need to perform the autonomous control, the processing burden of the flying object 10 is reduced and power consumption is also suppressed.

The following describes a second embodiment of the present invention with references to the drawings.

In the second embodiment, when the degree of risk in the airspace cells C where the flying object 10 flies is “medium”, a new flight plan 122 is generated by the server apparatus 20.

The hardware configuration and functional configuration of the flying object 10 and the server apparatus 20 are basically similar to the first embodiment described above. In this regard, however, the generating unit 111 generates the flight plan 122 different from the flight plan 121 described above when the degree of risk set by the setting unit 112 is equal to or more than a predetermined degree. The flight plan 122 includes the part of the first flight condition described in the flight plan 121. The flight plan 121 is an example of a first flight plan and the flight plan 122 is an example of a second flight plan. The transmitting unit 113 transmits the flight plans 121 and 122 to the flying object 10. The acquiring unit 114 acquires the flight plans 121 and 122 transmitted from the transmitting unit 113. The flight control unit 118 controls the flight of the flying object 10 in accordance with the first flight condition described in the flight plan 121 acquired by the acquiring unit 114, the part of the first flight condition and the second flight condition described in the flight plan 122 acquired by the acquiring unit 114, or the flight instruction acquired by the acquiring unit 114. For example, the flight control unit 118 may switch between the first flight control according to the first flight condition described in the flight plan 121, the second flight control according to the part of the first flight condition and the second flight condition described in the flight plan 122, and the third flight control according to the flight instruction, in accordance with the degree of risk set by the setting unit 112.

Operations

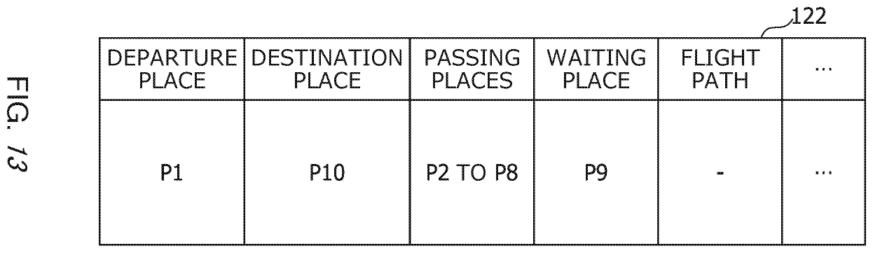

FIG. 12 is a sequence chart illustrating an example of operations of the flight control system 1 according to the second embodiment. Because the processes of Steps S301 to S307 are similar to the processes of Steps S101 to S107 explained in the first embodiment, their descriptions are omitted.

In Step S308, the flying object 10 transmits position information indicating the present position measured in Step S307 to the server apparatus 20. The server apparatus 20 receives the position information from the flying object 10.

In Step S309, the server apparatus 20 judges whether the degree of risk in the airspace cells C where the flying object 10 flies is “medium”. The airspace cells C where the flying object 10 flies are specified based on the position indicated by the position information received in Step S308. For example, when the flying object 10 flies in the airspace cell C3, it is judged that the degree of risk is “medium” (Step S309: YES) because the degree of risk in the airspace cell C3 set in Step S303 is “medium”. In this case, the process proceeds to Step S310.

In Step S310, the generating unit 111 of the server apparatus 20 generates the new flight plan 122 that includes the part of the flight plan 121.

FIG. 13 is a diagram illustrating an example of the flight plan 122. Similar to the flight plan 121 illustrated in FIG. 7, the departure place P1, the destination place P10, the passing places P2 to P8, and the waiting place P9 are described in the flight plan 122. In this regard, however, a flight path is not described in the flight plan 122.

In Step S311, the transmitting unit 113 of the server apparatus 20 transmits the flight plan 122 generated in Step S310 to the flying object 10. The acquiring unit 114 of the flying object 10 receives the flight plan 122 from the server apparatus 20.

In Step S312, the determining unit 117 of the flying object 10 determines a new flight condition, similar to Step S203 explained in the first embodiment. This flight condition is a flight condition that is not included in the flight plan 122. For example, the determining unit 117 determines the new flight path R2 toward the destination place P10 via the passing places P2 to P8 described in the flight plan 122.

In Step S313, the flight control unit 118 of the flying object 10 performs the autonomous control including some elements of the operational management control. More specifically, the flight control unit 118 performs the flight control in accordance with the flight conditions described in the flight plan 122 and the new flight condition determined in Step S312. For example, the flight control unit 118 performs the flight control to go through the new flight path R2 determined in Step S312. By such the flight control, the flying object 10 flies to the destination place P10 via the passing places P2 to P8 through the flight path R2.

On the other hand, in Step S309 described above, when it is judged that the degree of risk is “low” (Step S309: NO) for example, the processes of Steps S310 to S313 are not performed. In this case, the flying object 10 performs the same process as that of Step S202 explained in the first embodiment.

Moreover, in Step S309 described above, when it is judged that the degree of risk is “high” (Step S309: NO) for example, the processes of Steps S310 to S313 are not performed. In this case, a waiting instruction is transmitted from the server apparatus 20 to the flying object 10, for example. Upon receiving the waiting instruction from the server apparatus 20, the flying object 10 performs the same process as that of Step S205 explained in the first embodiment.

According to the second embodiment described above, when the degree of risk in the airspace cells C where the flying object 10 flies is “medium”, the flight plan 122 including the part of the flight plan 121 is transmitted from the server apparatus 20 to the flying object 10. Then, in the flying object 10, the autonomous control including some elements of the operational management control is performed based on the flight plan 122. In the autonomous control including some elements of the operational management control, the flying object 10 itself can determine some of the flight conditions, for example, in accordance with the status and environment of the flying object 10 independently of the flight plan 121. In this case, because a possibility that the flying object collides against an obstacle becomes low even if the obstacle exists in the airspace cells C for example, the safety of flight becomes high as compared to the case where the operational management control is performed. In this way, according to the second embodiment described above, as compared to the case where the operational management control is performed when the degree of risk in the airspace cells C where the flying object 10 flies is “medium”, safer flight control can be performed.

Modifications

The present invention is not limited to the embodiments described above. The embodiments described above may be modified as described below. Moreover, the following two or more modified examples may be implemented in combination.

In the embodiments described above, the degree of risk may be set during the flight of the flying object 10. For example, the degree of risk in the airspace cells C corresponding to the position of the flying object 10 may be set when the present position is measured by the flying object 10. The airspace cells C corresponding to the position of the flying object 10 may be the airspace cells C where the flying object 10 is currently flying or may be the airspace cells C where the flying object 10 flies from now on. In this case, when the present position of the flying object 10 is measured, position information indicating the present position is transmitted to the server apparatus 20. When the position information is received from the flying object 10, the setting unit 112 of the server apparatus 20 may set the degree of risk in the airspace cells C corresponding to the position indicated by the position information.

The flight conditions included in the flight plan 121 are not limited to the examples explained in the embodiments described above. For example, only some of the departure place, the destination place, the passing places, the waiting place, and the flight path may be included in the flight plan 121. In the other example, another flight condition on a flight distance may be described or a flight condition on a flight time or a flight speed may be described in the flight plan 121. The flight condition on the flight time may be a scheduled departure time, a scheduled arrival time, or a passing time of the passing place, for example. The flight condition on the flight speed may be a flight speed or an average flight speed, for example.

For example, the flight path may not be described in the flight plan 121. In this case, when the operational management control is performed, the flying object 10 determines a flight path toward the destination place P10 through the passing places P2 to P8 described in the flight plan 121 and flies through the determined flight path. On the other hand, when the autonomous control including some elements of the operational management control is performed, the flying object 10 may disable the passing places among the destination place and the passing places described in the flight plan 121 and determine new passing places and flight path. This flight path is determined to go toward the destination place described in the flight plan 121, for example. Moreover, the passing places are determined at spots on this flight path, for example.

In the other example, the flight speed, the scheduled departure time, and the scheduled arrival time may be further described in the flight plan 121. In this case, when the autonomous control including some elements of the operational management control is performed, the flying object 10 may disable a flight speed among the flight speed, the scheduled departure time, and the scheduled arrival time described in the flight plan 121 and determine a new flight speed. When taking off at the scheduled departure time for example, this flight speed is determined to arrive at the destination place at the scheduled arrival time.

In short, the flight conditions described in the flight plan 121 may be classified into first and second classes. Herein, the first-class flight conditions are enabled regardless of the degree of risk in the airspace cells C and the second-class flight conditions are disabled when the degree of risk in the airspace cells C is equal to or more than the predetermined degree, and these may be determined in the flying object 10. For example, the second-class flight conditions may be flight conditions more detailed than the first-class flight conditions. In the other example, the second-class flight conditions may be flight conditions obtained by using the first-class flight conditions.

In the embodiments described above, the degree of risk is expressed in three levels of “low”, “medium”, and “high”. However, the degree of risk may be expressed in two levels or less or four levels or more. Moreover, the degree of risk may be expressed by characters, numbers, or symbols other than “low”, “medium”, and “high”. In addition, the degree of risk may be set based on an element other than the elements explained in the embodiments described above. For example, the degree of risk may be set in accordance with the weather of the airspace where the flying object 10 flies.

In the embodiments described above, the method of measuring the position of the flying object 10 is not limited to the method of using GPS. The position of the flying object 10 may be measured by using a method that does not use GPS.

In the embodiments described above, the method of detecting an object located in the predetermined range of the flying object 10 is not limited to the method of using an image captured by the image capturing device 16. For example, an object located in a predetermined range from the flying object 10 may be detected by using a radar.

In the embodiments described above, at least part of the function of the server apparatus 20 may be implemented in the flying object 10. Similarly, at least part of the function of the flying object 10 may be implemented in the server apparatus 20.

The present invention may be provided as a flight control method including the steps of processing performed in the flight control system 1. Moreover, the present invention may be provided as a program executed in the flying object 10 or the server apparatus 20.

The block diagram illustrated in FIG. 5 illustrates blocks as a functional unit. These functional blocks (component parts) are realized by an arbitrary combination of hardware and/or software. Moreover, the implementation means of each functional block is not particularly limited. In other words, the functional blocks may be realized by one device connected physically and/or logically or may be realized by a plurality of devices obtained by connecting directly and/or indirectly (e.g., wired and/or wireless) two or more devices separated physically and/or logically.

The hardware configuration of the flying object 10 or the server apparatus 20 may be configured to include one device or two or more devices among the devices illustrated in FIG. 3 or FIG. 4, or may be configured not to include some of the devices. Moreover, the flying object 10 or the server apparatus 20 may be configured to include hardware such as a microprocessor, a digital signal processor (DSP), ASIC (Application Specific Integrated Circuit), PLD (Programmable Logic Device), and FPGA (Field Programmable Gate Array), or some or all of the functional blocks of the flying object 10 or the server apparatus 20 may be realized by this hardware. For example, the processor 11 or 21 may be implemented by at least one of these hardware devices.

The notification of information is not limited to the aspects/embodiments explained in the present specification and thus may be performed in another method. For example, the notification of information may be implemented by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), the other signals, or a combination of these. Moreover, the RRC signaling may be referred to as an RRC message. For example, the RRC signaling may be an RRC connection setup message, an RRC connection reconfiguration message, or the like.

Each aspect/embodiment explained in the present specification may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), a system using any other suitable system, and/or a next generation system expanded based on these.

Each of the processing procedure, the sequence, the flowchart, etc. of each aspect/embodiment explained in the present specification may change its sequential order as long as there is no contradiction. For example, the method explained in the present specification presents the elements of various steps in the exemplary order, but is not limited to the presented specific order.

The information etc. may be output from an upper layer (or a lower layer) to a lower layer (or an upper layer), and may be input and output via a plurality of network nodes.

The input and output information etc. may be saved in a specified place (e.g., memory) and may be managed with a management table. The information etc. to be input and output may be overwritten, updated, or added. The output information etc. may be deleted. The input information etc. may be transmitted to another device.

The judgment may be performed by a value (0 or 1) represented by one bit, may be performed by a Boolean value (Boolean: true or false), or may be performed by a numeric comparison (e.g., comparison with predetermined value).

Each aspect/embodiment explained in the present specification may be employed singly or in combination, or may be changed during execution. Moreover, predetermined information notification (e.g., notification of being “X”) may be performed implicitly (e.g., the predetermined information notification is not performed) without being limited to what is explicitly performed.

Software should be widely interpreted to mean instructions, an instruction set, codes, a code segment, program codes, a program, a subprogram, a software module, an application, a software application, a software package, a routine, a subroutine, objects, an executable file, an execution thread, a procedure, a function, and the like, regardless of whether it is referred to as software, firmware, middleware, microcode, and a hardware description language or is referred to as other names.

Moreover, software, instructions, etc. may be transmitted and received via a transmission medium. For example, when software is transmitted from a website, a server, or other remote sources by using wired technology such as a coaxial cable, an optical fiber cable, a twisted pair, and a digital subscriber line (DSL) and/or wireless technology such as infrared, wireless, and microwave, these wired technology and/or wireless technology are included in the definition of the transmission medium.

The information, signals, etc. explained in the present specification may be represented by any of various different technologies. For example, data, instructions, commands, information, signals, bits, symbols, chips, etc. mentioned throughout the above description may be represented by voltage, current, electromagnetic wave, a magnetic field or magnetic particles, an optical field or photons, or an arbitrary combination of these.

In addition, terms explained in the present specification and/or terms required to understand the present specification may be replaced by terms having the same or similar meaning. For example, a channel and/or a symbol may be a signal. Moreover, a signal may be a message. Moreover, a component carrier (CC) may be referred to as a carrier frequency, a cell, etc.

The terms called “system” and “network” that are used in the present specification are interchangeably used.

Moreover, the information, parameters, etc. explained in the present specification may be represented with an absolute value, may be represented with a relative value from a predetermined value, or may be represented with corresponding different information. For example, a wireless resource may be indicated by an index.

The names used for parameters described above are not limited in any respect. Furthermore, a mathematical expression etc. using these parameters may be different from what is explicitly disclosed in the present specification. Because various channels (e.g., PUCCH, PDCCH, etc.) and information elements (e.g., TPC etc.) can be identified by any suitable names, various names assigned to these various channels and information elements are not limited in any respect.

The term called “determining” that is used in the present specification may include a wide variety of operations. For example, the “determining” may include to regard “judging, calculating, computing, processing, deriving, investigating, looking up (e.g., looking up in table, database, or another data structure), ascertaining, etc.” as “determining”. Moreover, “determining” may include to regard “receiving (e.g., to receive information), transmitting (e.g., to transmit information), input, output, accessing (e.g., to access data in memory), etc.” as “determining”. Moreover, “determining” may include to regard “resolving, selecting, choosing, establishing, comparing, etc.” as “determining”. That is to say, “determining” may include to regard some operations as “determining”.

The terms “connected” and “coupled” or all these variants mean any direct or indirect connection or coupling between two or more elements, and mean that one or more intermediate elements can exist between two elements “connected” or “coupled” to each other. The coupling or connection between elements may be physical, may be logical, or may be a combination of these. When used in the present specification, two elements can be considered to be “connected” or “coupled” to each other by using one or more electric wires, cables, and/or printed electrical connections and by using electromagnetic energy of electromagnetic energy etc. having wavelengths of wireless frequency domain, microwave range, and light (both visible and invisible) region as some non-limiting and non-inclusive examples.

The description called “based on” that is used in the present specification does not mean “only based on” unless specifically stated otherwise. In other words, the description called “based on” means both “only based on” and “at least based on”.

Any reference to elements that use designations such as “the first” and “the second” used in the present specification does not generally limit the amounts or order of these elements. These designations may be used in the present specification as a convenient method to distinguish between two or more elements. Therefore, the reference to the first and second elements does not mean that only two elements can be employed therein or the first element must precede the second element in any kind of way.

A “means” in the configuration of each device described above may be replaced by a “unit”, a “circuit”, a “device”, etc.

The terms called “including” and “comprising”, and these variants are intended to be inclusive similar to the term “comprising” as long as they are used in the specification or claims. Furthermore, the term “or” that is used in the specification or claims is intended not to be an exclusive OR.

Throughout the present disclosure, when articles such as “a, an, and the” in English are added by translation, it is assumed that each of these articles indicates to include multiple things unless a corresponding one indicates to be clearly a single one from the context.

As described above, the invention has been described in detail, but it is obvious to those skilled in the art that the present invention is not limited to the embodiments described in the present specification. The present invention can be implemented as modifications and variations without departing from the spirit and scope of the present invention determined by the description of the claims. Therefore, the description of the present specification is for the purpose of illustration and explanation and does not have any limiting meaning with respect to the present invention.

### REFERENCE SIGNS LIST

1 Flight control system
10 Flying object
20 Server apparatus
111 Generating unit
112 Setting unit
113 Transmitting unit
114 Acquiring unit
115 Positioning unit
116 Detecting unit
117 Determining unit
118 Flight control unit

What is claimed is:

1-7. (canceled)

8. A flight control system comprising:
an acquiring unit configured to acquire a flight plan in which a first flight condition is described;
a setting unit configured to set a degree of risk in at least one airspace where a flying object flies;
a determining unit configured to determine a second flight condition based on an object detected within a predetermined range from the flying object, the predetermined range being included in the at least one airspace; and
a flight control unit configured to control flight of the flying object by switching between a first flight control method according to the flight condition and a second flight control method according to a part of the first flight condition and the determined second flight condition in accordance with the degree of risk,
wherein in a case where the degree of risk in an airspace included in the at least one airspace exceeds a predetermined level, the flight control unit selects the second flight control method to control the flying object in the airspace.

9. The flight control system according to claim 8, wherein the setting unit sets the degree of risk in accordance with a ground congestion degree corresponding to the airspace, an altitude in the airspace, a congestion degree in the airspace, an attribute of the airspace, or a flight operation of the flying object performed in the airspace.

10. The flight control system according to claim 8, wherein
the flight plan includes a passing place, a destination, and a path described therein,
the determining unit determines a new path toward the destination through the passing place described in the flight plan, and
the flight control unit controls the flight so that the flying object takes the determined new path in the second flight control method.

11. The flight control system according to claim 10, wherein the setting unit sets the degree of risk in accordance with a ground congestion degree corresponding to the airspace, an altitude in the airspace, a congestion degree in the airspace, an attribute of the airspace, or a flight operation of the flying object performed in the airspace.

12. The flight control system according to claim 8, wherein
the acquiring unit further acquires a flight instruction, and
the flight control unit switches between the first flight control method, the second flight control method, and a third flight control method according to the acquired flight instruction, in accordance with the degree of risk.

13. The flight control system according to claim 16, wherein the setting unit sets the degree of risk in accordance with a ground congestion degree corresponding to the airspace, an altitude in the airspace, a congestion degree in the airspace, an attribute of the airspace, or a flight operation of the flying object performed in the airspace.

14. The flight control system according to claim 12, wherein
the flight plan includes a passing place, a destination, and a path described therein,
the determining unit determines a new path toward the destination through the passing place described in the flight plan, and
the flight control unit controls the flight so that the flying object takes the determined new path in the second flight control method.

15. The flight control system according to claim 10, further comprising:
a positioning unit configured to measure a position of the flying object; and
a detecting unit configured to detect an object located within a predetermined range from the flying object, wherein
the determining unit determines the new path based on the measured position and the detected object.

16. The flight control system according to claim 15, wherein the setting unit sets the degree of risk in accordance with a ground congestion degree corresponding to the airspace, an altitude in the airspace, a congestion degree in the airspace, an attribute of the airspace, or a flight operation of the flying object performed in the airspace.

17. A flight control system comprising:
a setting unit configured to set a degree of risk in airspace where a flying object flies;
a generating unit configured to generate a second flight plan including a part of a first flight condition described in a first flight plan when the set degree of risk is equal to or more than a predetermined degree;
a transmitting unit configured to transmit the first flight plan and the generated second flight plan to the flying object;
an acquiring unit configured to acquire the transmitted first flight plan and second flight plan;
a determining unit configured to determine a second flight condition; and
a flight control unit configured to control flight of the flying object by switching between a first flight control method according to the first flight condition described in the acquired first flight plan and a second flight control method according to the acquired second flight plan and the determined second flight condition in accordance with the degree of risk.

18. A flight control apparatus comprising:
an acquiring unit configured to acquire a flight plan in which a first flight condition is described and a degree of risk in at least one airspace where a flying object flies;
a determining unit configured to determine a second flight condition based on an object detected within a predetermined range from the flying object, the predetermined range being included in the at least one airspace; and
a flight control unit configured to control flight of the flying object by switching between a first flight control method according to the first flight condition and a second flight control method according to a part of the first flight condition and the determined second flight condition in accordance with the degree of risk,
wherein in a case where the degree of risk in an airspace included in the at least one airspace exceeds a predetermined level, the flight control unit selects the second flight control method to control the flying object in the airspace.
